(19) United States
(12) Patent Application Publication
(10) Pub. No.: US 2012/0181785 A1
(43) Pub. Date: Jul. 19, 2012

(54) INTEGRATED TARGET HUB FLANGE FOR OILFIELD FRACTURING SYSTEMS

(75) Inventor: Saurabh KAJARIA, Houston, TX (US)

(73) Assignee: T-3 PROPERTY HOLDINGS, INC., Houston, TX (US)

(21) Appl. No.: 13/006,285

(22) Filed: Jan. 13, 2011

(51) Int. Cl. F16L 45/00

(52) U.S. Cl. 285/126.1

(57) ABSTRACT

The disclosure provides fittings having one or more inlets and one or more outlets with a target port and a target hub adapted to be coupled to the target port. The target hub is adapted to be removably coupled to the target port at a target coupler and sealingly engage the target port. The target hub includes a protrusion that protrudes into a flow path, where the protrusion includes a target face. A protrusion seal on the periphery of the protrusion sealingly engages a surrounding wall of the target port bore.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The disclosure generally relates oilfield applications having a pumping system with piping. More particularly, the disclosure relates to oilfield applications having a pumping system that pumps an abrasive fluid through piping for fracturing operations.

2. Description of the Related Art

FIG. 1A is an exemplary schematic diagram of a prior art fracturing system for an oilfield fracturing operation. FIG. 1B is an exemplary schematic diagram of a prior art fracturing system, showing fractures in an underlying formation.

FIG. 1C is an exemplary schematic diagram of the prior art fracturing system of FIG. 1A detailing a system for one well. The figures will be described in conjunction with each other. Oilfield applications often require pumping fluids into or out of drilled well bores 22 in geological formations 24. For example, hydraulic fracturing (also known as “fracing”) is a process that results in the creation of fractures 26 in rocks, the goal of which is to increase the output of a well 12. Hydraulic fracturing enables the production of natural gas and oil from rock formations deep below the earth's surface (generally 5,000-20,000 feet). At such depths, there may not be sufficient porosity and permeability to allow natural gas and oil to flow from the rock into the wellbore 22 at economic rates. The fracture 26 provides a conductive path connecting a larger area of the reservoir to the well, thereby increasing the area from which natural gas and liquids can be recovered from the targeted formation. The hydraulic fracture 26 is formed by pumping a fracturing fluid into the wellbore 22 at a rate sufficient to increase the pressure downhole to a value in excess of the fracture gradient of the formation rock. The fracture fluid can be any number of fluids, ranging from water to gels, foams, nitrogen, carbon dioxide, or air in some cases. The pressure causes the formation to crack, allowing the fracturing fluid to enter and extend the crack further into the formation.

To keep the fractures open after the injection stops, propping agents are introduced into the fracturing fluid and pumped into the fractures to extend the breaks and pack them with proppants, or small spheres generally composed of quartz sand grains, ceramic spheres, or aluminum oxide pellets. The proppant is chosen to be higher in permeability than the surrounding formation, and the propped hydraulic fracture then becomes a high permeability conduit through which the formation fluids can flow to the well.

In general, hydraulic fracturing equipment used in oil and natural gas fields usually includes frac tanks with fracturing fluid coupled through hoses to a slurry blender, one or more high-pressure, high volume fracturing pumps to pump the fracturing fluid to the well, and a monitoring unit. Associated equipment includes fracturing tanks, high-pressure treating iron, a chemical additive unit (used to monitor accurately chemical addition), pipes, and gauges for flow rates, fluid density, and treating pressure. Fracturing equipment operates over a range of pressures and injection rates, and can reach up to 15,000 psi (100 MPa) and 100 barrels per minute (265 L/s). Many frac pumps are typically used at any given time to maintain the very high, required flow rates into the well.

In the exemplary prior art fracturing system 2, fracturing tanks 4A-4F (generally “4”) deliver fracturing fluids to the well site and specifically to one or more blenders 8. The tanks 4 each supply the fluids typically through hoses 6A-6F (generally “6”) or other conduit to one or more blenders 8. One or more proppant storage units 3 can be fluidicly coupled to the blenders 8 to provide sand or other proppant to the blenders. Other chemicals can be delivered to the blenders for mixing. In most applications, the blenders 8 mix the fracturing fluids and proppant, and delivers the mixed fluid to one or more trucks 5A-5E (generally “5”) having high-pressure pumps 9A-9F (generally “9”) to provide the fluid through one or more supply lines 10A-10E (generally “10”) to a well 12A (generally “12”). The fluid is flushed out of a well using a line 14 that is connected to a dump tank 16. The fracturing operations are completed on the well 12A, and can be moved to other wells 12B and 12C, if desired.

FIG. 2 is an exemplary cross-sectional schematic view of an elbow fitting for piping in the fracturing system. FIG. 3 is an exemplary cross-sectional schematic view of a “Tee” fitting for piping in the fracturing system. The fracturing fluids are abrasive. At the high flow rates and high pressures, the fracturing fluids can erode the walls of the piping and particularly fittings that bend or otherwise change the direction of flow. For example, a typical elbow 28 shown in FIG. 2 has an inlet 30 establishing a first flow direction 34, a bend 34 establishing a change in flow direction, and an outlet 36 establishing a second flow direction 38. Progressive erosion typically occurs in a wear region 40 on the internal surfaces of the bend 34. Similarly, a typical Tee 42 shown in FIG. 3 has an inlet 30 establishing a first flow direction 34, a back wall 48 against which the flow impacts and changes direction, a first outlet 36 establishing a second flow direction 38, and a second outlet 44 establishing a third flow direction 46. Progressive erosion typically occurs in a wear region 50 on the internal surfaces of the back wall 48.

Thus, there is a need to protect the fittings from unnecessary and premature wear when pumping the abrasive fracturing fluids that provide ready maintenance and replacement if required.

### BRIEF SUMMARY OF THE INVENTION

The disclosure provides fittings having one or more inlets and one or more outlets with a target port and a target hub adapted to be coupled to the target port. The target hub is adapted to be removably coupled to the target port at a target coupler and sealingly engage the target port. The target hub includes a protrusion that protrudes into a flow path, where the protrusion includes a target face. A protrusion seal on the periphery of the protrusion sealingly engages a surrounding wall of the target port bore.

The disclosure provides a fitting for an oilfield fracturing system having abrasive fluid, comprising: at least one inlet establishing a first flow direction for fluid to enter the fitting; at least one outlet establishing a second flow direction for fluid to exit the fitting; a target port at least partially aligned with at least one of the inlets and having a bore; and a target hub adapted to be coupled to the target port to intercept the abrasive fluid flowing in the first flow direction before exiting the fitting in the second flow direction, the target hub having a protrusion extending into the bore of the target port and having a protrusion seal disposed between the bore and the protrusion.

The disclosure provides a method of resisting erosion in fittings from abrasive fluids in an oilfield fracturing system, comprising: flowing the abrasive fluid into a fitting having at least one inlet to establish a first flow direction; impacting a protrusion on a target hub with the abrasive fluid while sealing the target hub protrusion in a bore of the fitting; and turning the abrasive fluid to a second flow direction to exit the fitting.

### BRIEF DESCRIPTION OF THE SEVERAL VIEWS OF THE DRAWINGS

FIG. 1A is an exemplary schematic diagram of a prior art fracturing system for an oilfield fracturing operation.

FIG. 1B is an exemplary schematic diagram of a prior art fracturing system, showing fractures in an underlying formation.

FIG. 1C is an exemplary schematic diagram of the prior art fracturing system of FIG. 1A detailing a system for one well.

FIG. 2 is a cross-sectional schematic view of an exemplary prior art elbow fitting for piping in the fracturing system.

FIG. 3 is a cross-sectional schematic view of an exemplary prior art “Tee” fitting for piping in the fracturing system.

FIG. 4 is a cross-sectional schematic view of an exemplary modified elbow fitting having an inlet, an outlet, a target port, and a target hub, according to the invention.

FIG. 5 is a cross-sectional schematic view of an exemplary modified Tee fitting having an inlet, two outlets, a target port, and a target hub, according to the invention.

FIG. 6 is a perspective schematic view of an exemplary target hub.

FIG. 7 is a top schematic view of the target hub of FIG. 6.

FIG. 8 is a cross-sectional schematic view of the target hub of FIG. 7 through the cross-sectional line 8-8.

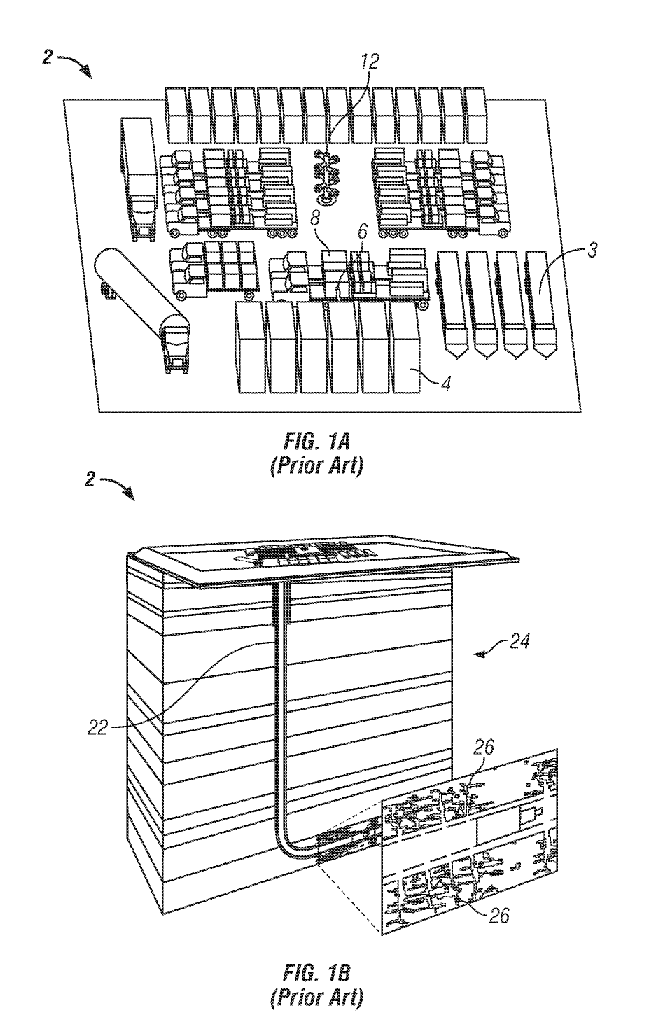

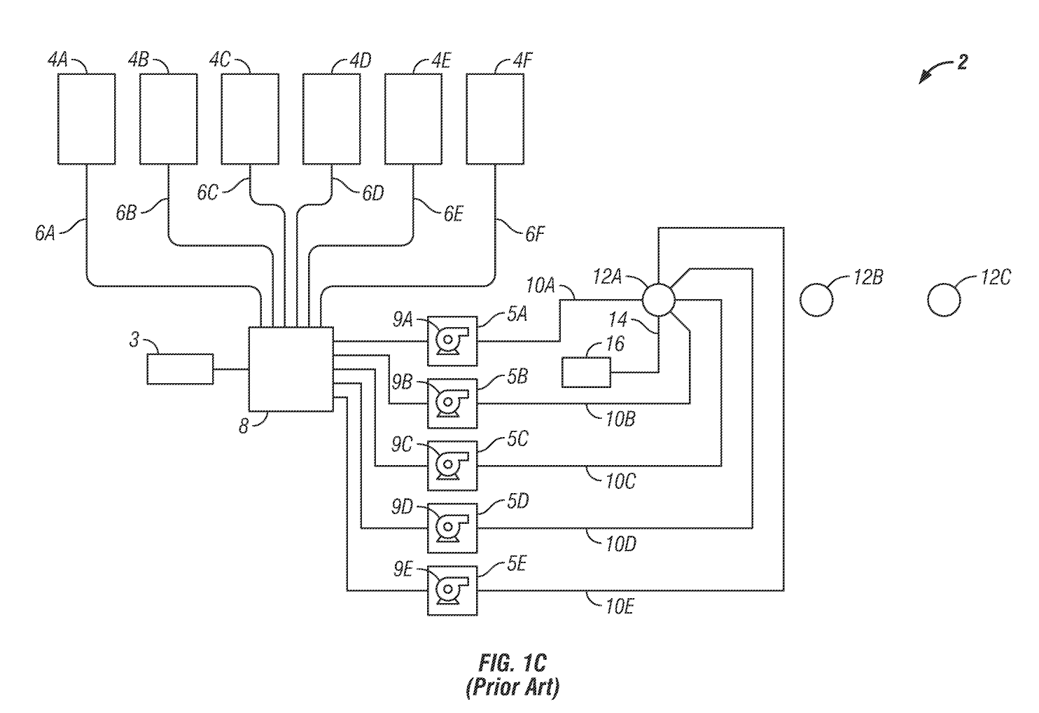

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. Where appropriate, some elements have been labeled with an “a” or “b” to designate one side of the system or another. When referring generally to such elements, the number without the letter is used. Further, such designations do not limit the number of elements that can be used for that function.

The disclosure provides fittings having one or more inlets and one or more outlets with a target port and a target hub adapted to be coupled to the target port. The target hub is adapted to be removably coupled to the target port at a target coupler and sealingly engage the target port. The target hub includes a protrusion that protrudes into a flow path, where the protrusion includes a target face. A protrusion seal on the periphery of the protrusion sealingly engages a surrounding wall of the target port bore.

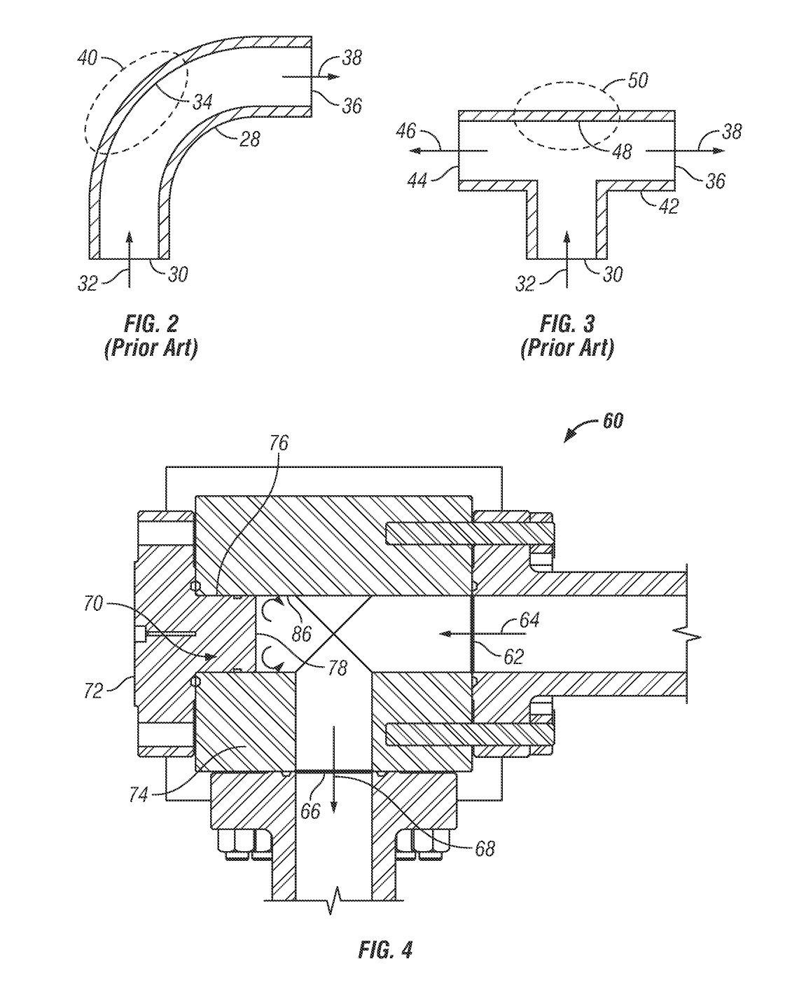

FIG. 4 is a cross-sectional schematic view of an exemplary modified elbow fitting having an inlet, an outlet, a target port, and a target hub, according to the invention. A modified fitting, such as an elbow 60, generally includes one or more inlets, such as inlet 62, and one or more outlets, such as outlet 66. The inlet 62 establishes a first flow direction 64 for fluid entering the modified fitting. The outlet 66 establishes a second flow direction 68 for fluid exiting the fitting. The modified fitting includes a target port 70 having a bore. A target hub 72 is coupled to the target port 70. The target port at least partially aligned with the inlet 62 to at least partially receive the incoming fluid in the first flow direction 64 and the associated impact of particles in the fluid. The target port 70 generally includes some means of coupling the target hub to the port. In at least one embodiment, the target port includes a target coupler 74, such as a flange or a flange configuration with holes bored into the outside face of the target port. Other types of couplers can include quick disconnects, threaded connections, and other types of connections known to those with ordinary skill in the art.

The target hub 72 generally includes a protrusion 76 disposed in the bore 86 of the target port 70. The protrusion 76 includes a target face 78 that generally is aligned in a direction opposing the first flow direction 64 through the inlet 62. While the target face 78 is illustrated generally perpendicular to the inlet 62 and the first flow direction 64, it is to be understood that various angles besides perpendicular can be formed and may be appropriate in particular circumstances. As will be described below, the target hub 72 can include a target hub seal between the target hub 72 and the target port 70, and a protrusion seal between the protrusion 76 to the surface of the target port bore 86.

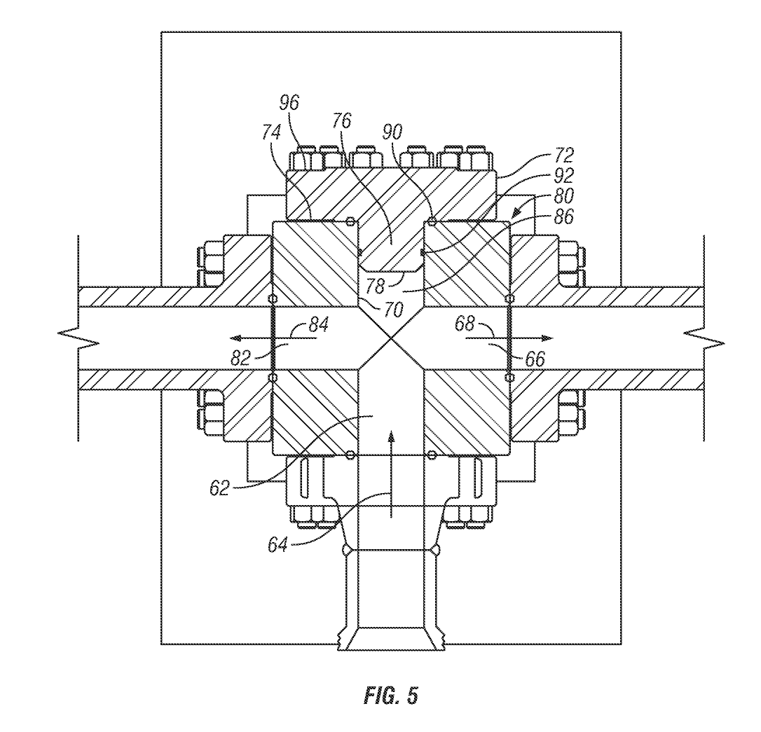

FIG. 5 is a cross-sectional schematic view of an exemplary modified Tee fitting having an inlet, two outlets, a target port, and a target hub, according to the invention. Similar to the elbow 60 described above, a modified fitting according to intervention can include a Tee 80. The Tee 80 generally includes one or more inlets and one or more outlets. In the illustrated embodiment, the Tee 80 includes an inlet 62 establishing a first flow direction 64, a first outlet 66 establishing a second flow direction 68, and a second outlet 82 establishing a third flow direction 84. In the illustrated embodiment, the second flow direction and third flow direction are aligned in opposite directions. However, it is to be understood that the multiple outlets can be disposed relative to each other at different directions and angles. The Tee 80 includes a target port 70 with a target hub 72 coupled thereto. The target hub 72 can be coupled to a target coupler 74 of the target port 70. A protrusion 76 can be disposed in the target port bore 86, so that a target face 78 on the protrusion can deflect incoming fluid through the inlet 62.

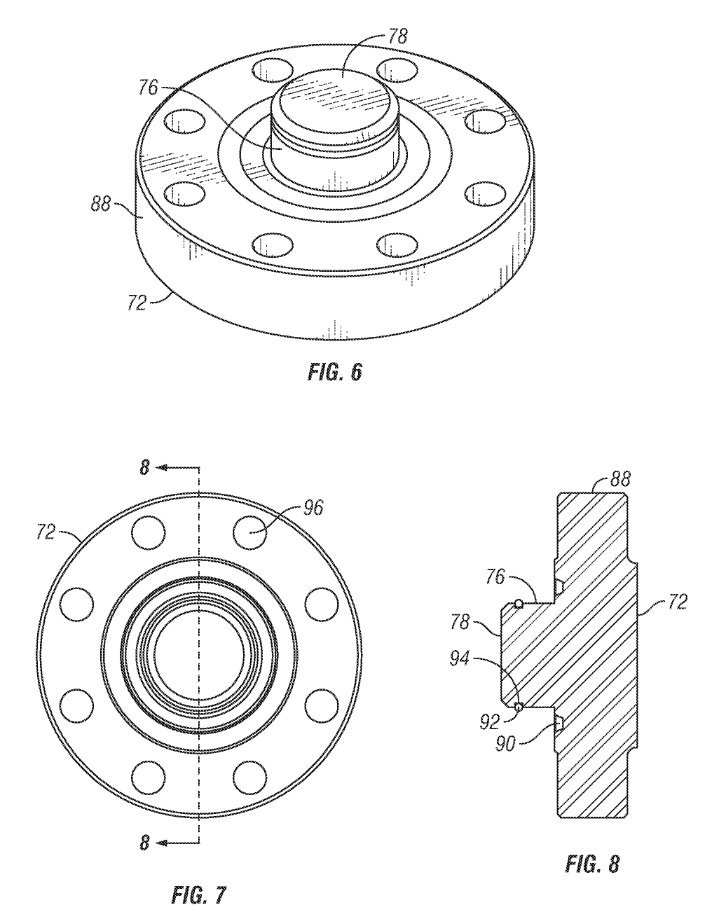

FIG. 6 is a perspective schematic view of an exemplary target hub. FIG. 7 is a top schematic view of the target hub of FIG. 6. FIG. 8 is a cross-sectional schematic view of the target hub of FIG. 7 through the cross-sectional line 8-8. The figures will be described in conjunction with each other. The target hub 72 can have a variety of shapes. In the embodiment illustrated herein, the target hub includes a target hub coupler 88. As a practical matter, a target hub coupler in the form of a flange can be conducive to the sizes and pressures of fitting in fracturing operations. However, it is to be understood that various other types of coupling and shapes can be used as appropriate for the given application. Thus, in general, the target hub coupler 88 represents a coupler for the target hub to the target port described above. In the embodiment shown in FIG. 7, the target hub coupler 88 can include a plurality of bolt holes 96 for coupling the target hub 72 with the target coupler 74.

The target hub 72 includes the protrusion 76 having a target face 78. The target face 78 is generally illustrated perpendicular to a longitudinal axis through the target hub 72. However, angles and shapes can be used. The target hub 72 can include a target hub seal 90. The target hub seal 90 can sealingly engage the target hub 72 with the target coupler 74, described above in FIGS. 4 and 5. The protrusion 76 can further include a protrusion seal 92 that can sealingly engage the protrusion 76 with the target port bore 86, described above in FIGS. 4 and 5. The protrusion seal 92 can be a variety of seals, including without limitation, O-rings, chevron seals, metal seals, and other types of seals known to those with ordinary skill in the art.

The protrusion seal 92 provides additional sealing for the target hub 72 to the target port 70, given the nature of the fluids and abrasive contact with surfaces. The fittings and associated components sealingly engaged therewith expand by some amount during pressurization and contract during depressurization. The repetitive expansion and contraction allows the abrasive particles in the fluid to become positioned adjacent the target hub seal 90 and its sealing surfaces and can deteriorate the seal or sealing surfaces or otherwise inhibit and compromise the sealing. The protrusion seal 92 helps isolate particles in the fluid from becoming positioned between the target hub seal 90 and its sealing surfaces on the target port 70, the target hub 72, or both, during pressurization and fluid flow. The target hub seal 90 can maintain overall pressure integrity to the fitting in the target port/target hub zone. The protrusion seal 92 can be fitted to the target hub 72 along the perimeter of the protrusion 76, such as in a sealing groove 94.

Other and further embodiments utilizing one or more aspects of the inventions described above can be devised without departing from the spirit of the disclosed invention. Further, the various methods and embodiments of the system can be included in combination with each other to produce variations of the disclosed methods and embodiments. Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope or range of equivalent of the following claims.

What is claimed is:

1. A fitting for an oilfield fracturing system having abrasive fluid, comprising:
at least one inlet establishing a first flow direction for fluid to enter the fitting;
at least one outlet establishing a second flow direction for fluid to exit the fitting;
a target port at least partially aligned with at least one of the inlets and having a bore; and
a target hub adapted to be coupled to the target port to intercept the abrasive fluid flowing in the first flow direction before exiting the fitting in the second flow direction, the target hub having a protrusion extending into the bore of the target port and having a protrusion seal disposed between the bore and the protrusion.

2. The fitting of claim 1, wherein the fitting comprises an elbow fitting.

3. The fitting of claim 1, wherein the fitting comprises a Tee fitting further comprising a second outlet to establish a third flow direction.

4. The fitting of claim 1, wherein the target port further comprises a target coupler adapted to removably couple the target hub with the target port.

5. The fitting of claim 4, wherein the target coupler comprises a flange having bolt holes adapted to be coupled to the target hub with a flange having bolt holes.

6. The fitting of claim 1, further comprising a target hub seal disposed between the target hub and the target port in addition to the protrusion seal.

7. A method of resisting erosion in fittings from abrasive fluids in an oilfield fracturing system, comprising:
flowing the abrasive fluid into a fitting having at least one inlet to establish a first flow direction;
impacting a protrusion on a target hub with the abrasive fluid while sealing the target hub protrusion in a bore of the fitting; and
turning the abrasive fluid to a second flow direction to exit the fitting.

8. The method of claim 7, further comprising removably coupling the target hub to a target coupler on the target port.

9. The method of claim 7, wherein the target hub is disposed at a bend in an elbow fitting.

10. The method of claim 7, wherein the target hub is at least partially aligned with the first flow direction and further comprising opposing the flow of the abrasive fluid with a target face on the protrusion.

11. The method of claim 10, further comprising turning the abrasive fluid to a third flow direction to exit the fitting in addition to the second flow direction.
